(19) United States
(12) Patent Application Publication
(10) Pub. No.: US 2015/0095178 A1
(43) Pub. Date: Apr. 2, 2015

(54) GROUP DISCOUNT MEDIA PRICING

(71) Applicant: Apple Inc., Cupertino, CA (US)

(72) Inventors: Mehul K. Sanghavi, Sunnyvale, CA (US); Michael Froimowitz Greenzeiger, Sunnyvale, CA (US); Ravindra Phulari, San Jose, CA (US)

(73) Assignee: Apple Inc, Cupertino, CA (US)

(21) Appl. No.: 14/043,918

(22) Filed: Oct. 2, 2013

(51) Int. Cl. G06Q 30/06

(52) U.S. Cl. CPC G06Q 30/0605
USPC 705/26.2

(57) ABSTRACT

Systems, methods, and non-transitory computer-readable storage media for group discount pricing for mobile content. The system first provides a group invitational content associated with an item for presentation at a display, the group invitational content indicating a discount price provided for the item if a number of offers are made to purchase the item within a period of time. Next, the system receives an offer to purchase the item at the discount price according to the group invitational content. The system then sends an indication of the offer to a list of purchases associated with the group invitational content, the indication prompting the offer to be added to the list of purchases.

### TECHNICAL FIELD

The present technology pertains to advertising, and more specifically pertains to group discount media pricing for mobile content.

### BACKGROUND

In recent years, mobile advertising has become a popular tool used by retailers to promote their paid applications and other content downloads to users of mobile devices. With mobile advertising, retailers can expand their marketing reach to an ever-growing base of mobile users. Moreover, users can conveniently purchase the advertised products directly from their mobile device, at any time and from any place. The convenience and widespread reach of mobile advertising can increase the user's exposure and receptivity to the invitational content, which often leads to greater sales. Both the retailer and the mobile user can benefit from mobile advertising, as the retailer can effectively market her product and the mobile user can find a desired product at an acceptable price.

Typically, mobile invitational content is displayed at the user's mobile device with an offer to sell content to the user at a fixed price per download according to the regular price of the content. Here, retailers have little flexibility in pricing their products according to volume, as they are not guaranteed a sufficient volume of purchases to make a significant financial return. Unfortunately, current solutions do not otherwise provide group offers with varying pricing structures based on specific guaranteed volumes of purchases. Consequently, retailers often miss out on significant potential marketing benefits of mobile invitational content.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The approaches set forth herein can be used to provide mobile invitational content with group discount pricing. Retailers can offer group discounts on products and services with offer deadlines and volume guarantees. The lower pricing and volume incentives can spur increased demand for purchases and potentially expose users to new products they wouldn't otherwise try. Retailers can make sure that enough quantities of a product are sold at a lower price to ensure a sufficient financial return. Users also have a greater incentive to increase the volume of purchases in order to decrease the price of the product, which translates to increased word-of-mouth referrals and improved download rankings within application or content stores. This can result in a burst in downloads, which can also aid in the discovery by users. Moreover, the approaches set forth herein can be used to advertise any content, including applications, standalone content items, and even “freemium” content within applications that the user already owns.

Disclosed are devices, systems, methods, and non-transitory computer-readable storage media for group discount pricing for mobile content. The system presents a group invitational content for an item, the group invitational content indicating a discount price provided for the item if a number of offers are made to purchase the item within a period of time. The system can also present and/or display a timer indicating an amount of time left before the group invitational content expires. This can be the amount of time remaining in the period of time associated with the group invitational content. The group invitational content can be presented to a user at the user's device. For example, the group invitational content can be a mobile invitational content presented to the user at a mobile device, such as a smartphone or a tablet computer. Also, the system can receive the group invitational content from another device, such as a server, for example.

In some cases, the group invitational content can also indicate the full price of the item. The group invitational content can also indicate additional discount prices for the item based on a different number of purchases made within the period of time or a different period of time, for example. The group invitational content can be for any product or service. For example, the group invitational content can be for media content, such as a mobile application or a music file. Further, the discount price can be based on the number of purchases. For example, the discount price can decrease as the number of purchases also increases. In this sense, the discount price can be static or tiered. However, in some aspects, the discount price can be dynamic. Here, the system can determine when to launch discounts and/or how much to discount. This can be subject to constraints set in advertiser preferences for a minimum price and a maximum number and/or duration of discounts offered. The system can optimize the discount price to maximize advertiser profit. Moreover, the system can keep track of how much profit (e.g., cost charged for application and/or content minus the cost to the advertiser, such as a cost per action amount charged by the advertising network) was made on a per impression unit basis for each burst of discounts offered. When determining what price to use for a subsequent discount burst, the system can choose whichever price previously performed best within a configurable time window, such as a week, a month, and so forth. The system can then choose to add n cents, subtract n cents, or keep the original value, where n can be a configurable parameter determining how exploratory the pricing algorithm should be. In addition, the record of past pricing performance can be reset any time the overall targeting of the algorithm is altered, with the initial post-reset value being the best performing price under the old targeting, for example.

Next, the system receives an offer to purchase the item at the discount price according to the group invitational content. The system then adds the offer to a list of purchases associated with the group invitational content. Based on the list of purchases, the system can update the group invitational content to indicate how many purchases of the item have been made and/or how many additional purchases of the item must be made according to the offer. The system can accept the offer to purchase the item when the number of offers are made. Here, the system can finalize the purchase of the item. If the period of time expires before the number of offers are made, the system can present an option to purchase the item at the full price or any other price determined by the system or advertiser.

In some embodiments, the system presents the group invitational content to multiple users at their respective devices and receives multiple offers to purchase the item at the discount price within the period of time. The system then adds the multiple offers to purchase the item to the list of purchases. The system can also update the group invitational content to indicate how many offers have been received, how many additional offers must be received according to the group discount, and/or how much time remains before the group discount expires. When the number of offers received meets the number of offers required by the group invitational content for the particular discount price, the system can accept the offers and finalize the purchases. If the number of offers received do not meet the number of offers required when the period of time expires, the system can present the users that made an offer with an offer to purchase the item at the full price and/or any price determined by the system or advertiser.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary configuration of devices and a network;

FIG. 2 illustrates an exemplary group invitational content;

FIG. 3 illustrates an exemplary presentation of a group invitational content for mobile content;

FIG. 4 illustrates an exemplary presentation of a dynamic group invitational content for mobile content;

FIG. 5 illustrates an exemplary discount pricing graph;

FIG. 6 illustrates a first exemplary method embodiment;

FIG. 7 illustrates a second exemplary method embodiment; and

FIGS. 8A and FIG. 8B illustrate exemplary system embodiments.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

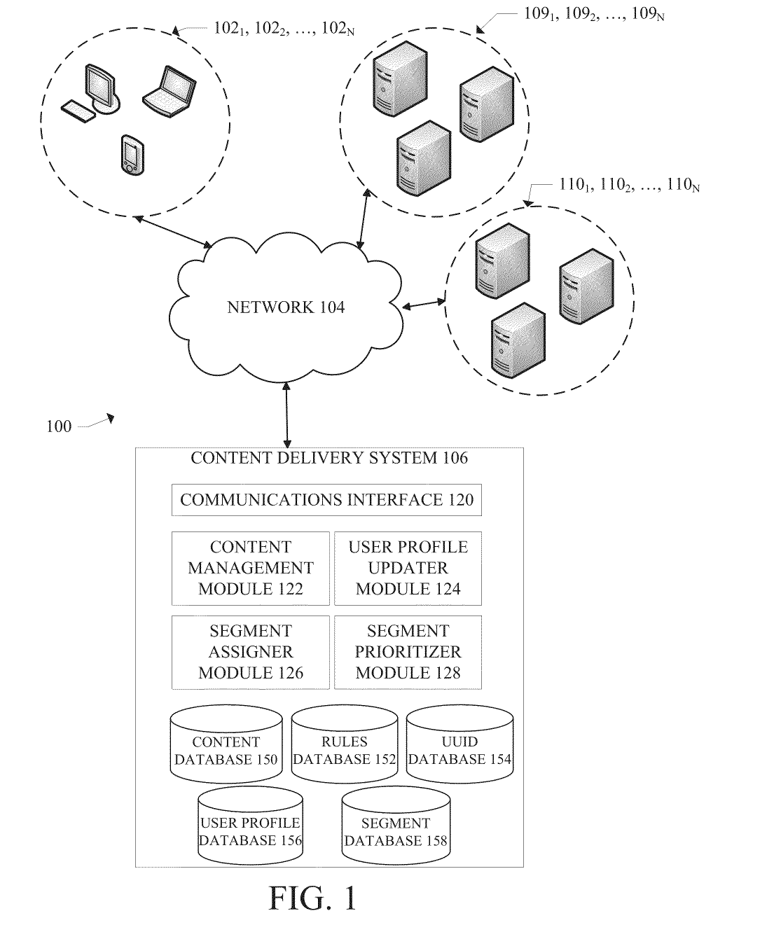

The disclosed technology addresses the need in the art for effective and convenient group discount pricing. Disclosed are systems, methods, and non-transitory computer-readable storage media for group discount pricing for mobile content. A brief introductory description of an exemplary configuration of devices and a network is disclosed herein. A more detailed description of group discount pricing will then follow. These variations shall be described herein as the various embodiments are set forth. The disclosure now turns to FIG. 1.

An exemplary system configuration 100 is illustrated in FIG. 1, wherein electronic devices communicate via a network for purposes of exchanging content and other data. The system can be configured for use on a wide area network such as that illustrated in FIG. 1. However, the present principles are applicable to a wide variety of network configurations that facilitate the intercommunication of electronic devices. For example, each of the components of system 100 in FIG. 1 can be implemented in a localized or distributed fashion in a network.

In system 100, invitational content can be delivered to user terminals 102₁, 102₂, . . . , 102ₙ (collectively “102”) connected to a network 104 by direct and/or indirect communications with a content delivery system 106. User terminals 102 can be any network enabled client devices, such as desktop computers; mobile computers; handheld communications devices, e.g. mobile phones, smart phones, tablets; smart televisions; set-top boxes; and/or any other network enabled computing devices. Furthermore, content delivery system 106 can concurrently accept connections from and interact with multiple user terminals 102.

The content delivery system 106 can receive a request for electronic content, such as a web page, an application, a media item, etc., from one of user terminals 102. Thereafter, the content delivery system 106 can assemble a content package and transmit the assembled content page to the requesting one of user terminals 102. To facilitate communications with the user terminals 102 and/or any other device or component, the content delivery system 106 can include a communications interface 120.

The content delivery system 106 can include a content management module 122 to facilitate the generation of an assembled content package. Specifically, the content management module 122 can combine content from one or more primary content providers 109₁, 109₂, . . . , 109ₙ (collectively “109”) and content from one or more secondary content providers 110₁, 110₂, . . . 110ₙ (collectively “110”) to generate the assembled content package for the user terminals 102. For example, in the case of a web page being delivered to a requesting one of user terminals 102, the content management module 122 can assemble a content package by requesting the data for the web page from one of the primary content providers 109 maintaining the web page. For the invitational content on the web page provided by the secondary content providers 110, the content management module 122 can request the appropriate data according to the arrangement between the primary and secondary content providers 109 and 110. Additionally, the content management module 122 can create content packages that contain content from a single content provider. That is, a content package can contain only primary content or a content package can contain only secondary content. However, the content package is not limited to the content from content providers 109 and 110. Rather, the content package can include other data generated at the content delivery system 106. In some embodiments, the content delivery system 106 can preselect the content package before a request is received.

An assembled content package can include text, graphics, audio, video, executable code, or any combination thereof. Further, an assembled content package can include invitational content designed to inform or elicit a pre-defined response from the user. In some embodiments, the invitational content can be associated with a product or can directly or indirectly advertise a product. For example, the assembled content package can include one or more types of advertisements from one or more advertisers.

Additionally, the invitational content can be active invitational content. That is, invitational content that is designed to primarily elicit a pre-defined response from a user. For example, active invitational content can include one or more types of advertisements configured to be clicked upon, solicit information, or be converted by the user into a further action, such as a purchase or a download of the advertised item. However, invitational content can also be passive invitational content. That is invitational content that is designed to primarily inform the user, such as a video. In some cases, passive invitational content can include information that can lead or direct users to other invitational content including active invitational content.

Furthermore, the invitational content can be dynamic invitational content. That is invitational content that varies over time or that varies based on user interaction. For example, dynamic invitational content can include an interactive game. However, the various embodiments are not limited in this regard and the invitational content can include static invitational content that neither varies over time nor with user interaction. In the various embodiments, invitational content in a content package can be static or dynamic and active or passive. A content package can include a combination of various types of invitational content in a single content package.

In some cases, a content package can replace or update invitational content in a content package already delivered to a user terminal. For example, a first content package can include an app that can be installed on the user terminal 102ᵢ. A subsequent content package can include one or more items of invitational content that can be presented to a user of the user terminal 102ᵢ while the user interacts with the app.

Although primary and secondary providers 109 and 110 are presented herein as separate entities, this is for illustrative purposes only. In some cases, the primary and the secondary content providers 109 and 110 can be the same entity. Thus, a single entity can provide both the primary and the secondary content.

The content management module 122 can be configured to request that content be sent directly from content providers 109 and 110. Alternatively, a cached arrangement can also be used to improve performance of the content delivery system 106 and improve overall user experience. That is, the content delivery system 106 can include a content database 150 for locally storing/caching content maintained by content providers 109 and 110. The data in the content database 150 can be refreshed or updated on a regular basis to ensure that the content in the database 150 is up to date at the time of a request from a user terminal 102ᵢ. However, in some cases, the content management module 122 can be configured to retrieve content directly from content providers 109 and 110 if the metadata associated with the data in the content database 150 appears to be outdated or corrupted.

As described above, content maintained by the content providers 109 and 110 can be combined according to a predefined arrangement between the two content providers, which can be embodied as a set of rules. In an arrangement where the content delivery system 106 assembles the content package from multiple content providers, the assembly rules can be stored in a rules database 152 in the content delivery system 106. The content management module 122 can be configured to assemble the content package for user terminals 102 based on these rules. The rules can specify how to select content from secondary content providers 110 and primary content providers 109 in response to a request from one of user terminals 102. For example, in the case of a web page maintained by one of primary content providers 109 and including invitational content, the rules database 152 can specify rules for selecting one of the secondary providers 110. The rules can also specify how to select specific content from the selected one of secondary providers 110 to be combined with the content provided by one of primary providers 109. In some cases, an item of primary content, such as an app or other media object, can have one or more associated attributes. For example, an app can have one or more associated genre attributes, e.g. travel, sports, education, etc. A rule can be based at least in part on the primary content attributes. Once assembled, the assembled content package can be sent to a requesting one of user terminals 102.

Additionally, rules for combining primary and secondary content can be based on user characteristics known about the user. In particular, in some cases, invitational content can be selected based on the characteristics of the requesting user(s). As used herein, the term “user characteristics” refers to the characteristics of a particular user associated with one or more of user terminals 102. User characteristics can include channel characteristics, demographic characteristics, behavioral characteristics, and spatial-temporal characteristics. Channel characteristics can define the specific delivery channel being used to deliver a content package to a user. For example, channel characteristics can include a type of electronic content, a type of device or user terminal, a carrier or network provider, or any other characteristic that defines a specific delivery channel for the content package. Spatial-temporal characteristics can define a location, a location zone, a date, a time, or any other characteristic that defines a geographic location and/or a time for delivery of the content package. Demographic characteristics can define characteristics of the users targeted by the content or associated with the content. For example, demographic characteristics can include age, income, ethnicity, gender, occupation, or any other user characteristics. Behavioral characteristics can define user behaviors for one or more different types of content, separately or in combination with any other user characteristics. That is, different behavioral characteristics may be associated with different channel, demographic, or spatial-temporal characteristics. User characteristics can also include characteristics descriptive of a user's state of mind including characteristics indicative of how likely a user is to click on or convert an item of invitational content if it were displayed to the user. User characteristics can be learned directly or derived indirectly from a variety of sources. In some embodiments, the user characteristic values can be collected from one or more databases. For example, if the user is registered with an online media service, such as the ITUNES store maintained by Apple Inc. of Cupertino, Calif., the collected data could include the user's registration information. Such data can provide values for declared user characteristics. Furthermore, the content delivery system 106 can be configured to learn of or derive user characteristics from any number of other information sources. For example, in some configurations, the content delivery system 106 can derive or infer one or more user characteristic values from user characteristic values already known about the user.

In some embodiments, the interactive content can be associated with one or more targeted segments. A targeted segment can be viewed as defining a space or region in k-dimensional space, where each of the k dimensions is associated with one of a plurality of user characteristics. In the various embodiments, the k dimensions can include both orthogonal and non-orthogonal dimensions. That is, some of the k dimensions can overlap or can be related in some aspect.

In the various embodiments, the content delivery system 106 can also include a unique user identifier (UUID) database 154 that can be used for managing sessions with the various user terminal devices 102. The UUID database 154 can be used with a variety of session management techniques. For example, the content delivery system 106 can implement an HTTP cookie or any other conventional session management method (e.g., IP address tracking, URL query strings, hidden form fields, window name tracking, authentication methods, and local shared objects) for user terminals 102 connected to content delivery system 106 via a substantially persistent network session. However, other methods can be used as well. For example, in the case of handheld communications devices, e.g. mobile phones, smart phones, tablets, or other types of user terminals connecting using multiple or non-persistent network sessions, multiple requests for content from such devices may be assigned to a same entry in the UUID database 154. The content delivery system 106 can analyze the attributes of requesting devices to determine whether such requests can be attributed to the same device. Such attributes can include device or group-specific attributes.

In some embodiments, the content delivery system 106 can include a user-profile database 156. The user-profile database 156 can, at least in part, be constructed based on declared user characteristics related to one or more users. In some cases, the user-profile database may contain inferred or derived user characteristic values. The user-profile database 156 can be updated using a user-profile-updater module 124. In some embodiments, the user-profile-updater module 124 can be configured to add additional profile data, update profile data, fill in missing profile data, or infer user characteristic values from declared data.

The user-profile-updater module 124 can also be configured to maintain the user profile database 156 to include only more recently acquired data or to re-derive any inferred characteristics in order to ensure that the user profile is an accurate reflection of the current state of the user (location, state of mind, behaviors, demographics, etc. can change rapidly). For example, the user-profile-updater module 124 can be configured to maintain the user profile database 156 to include only data from the last two to three months. However, the user-profile-updater module 124 can be configured to adjust the data in the user profile database 156 to cover any span of time. In some instances the user-profile-updater module 124 can update the profile database 156 in real-time. Alternatively, the user-profile-updater module 124 can be configured to set an expiration period on a subset of the data in the user profile database 156. For example, a policy can specify that user declared data is maintained as long as the user account is active, but user characteristic values based on location information expire after a specified period of time. In some cases, a user can set the expiration period. In some instances, the user-profile-updater module 124 can update the user profile database 156 at least every week, or every day. In some cases, the content delivery system 106 can receive a direct request to update one or more user profiles. The update request can come directly from the user's device or any other device capable of communicating with the content delivery system 106, such as other content delivery networks or websites. In some cases, the content delivery system 106 can receive an indirect request to update one or more user profiles. An indirect request can be the result of receiving new user characteristic values. An update request can occur at any time.

In some embodiments, the content delivery system 106 can include a segment database 158 that is used to aid in selecting invitational content to target to users. The segment database 158 can store defined segments and associations between the segments and users and/or invitational content that should be targeted to users associated with the segments. As described above, a targeted segment can be defined based on one or more user characteristics or derivatives thereof and can be associated with one or more items of invitational content. Additionally, a targeted segment can be associated with one or more users. In some embodiments, by associating a targeted segment with both a user and an item of invitational content, the delivery system can match invitational content with users. In some embodiments, the content delivery system 106 can update the segment database 158 to add newly defined targeted segments or to delete targeted segments.

In some cases a targeted segment can be as simple as a single user characteristic identifier and a single user characteristic value. For example, the common demographic identifiers of gender, age, occupation, or income can each be used in defining corresponding targeted segments. A characteristic value can also be assigned to the identifier. For example, the values of male, 19, and student can be assigned to the user characteristics of gender, age, and occupation, respectively. However, more complex targeted segments can also be defined that consist of one or more identifiers with one or more values associated with each identifier. For example, a targeted segment can be defined to target a user with the following characteristics: gender, male; age, 19-24; location, Northern California or New York City. Additional exemplary segments are described throughout this disclosure. Furthermore, targeted segments can correspond to one or more segments that content providers are likely to easily understand and thus can quickly identify as being relevant to their content. Additionally, in some embodiments, content providers 109 and 110 can define a custom targeted segment.

In some embodiments, the content delivery system 106 can provide a segment assigner module 126. The segment assigner module 126 can apply a set of user characteristics associated with a user (including segments to which a user has been previously assigned) to assign the user to one or more targeted segments. The assigner module 126 can obtain the set of user characteristic values from the user profile database 154 and/or from the user's activities during the current session. The segment assigner module 126 can assign a user to one or more defined targeted segments in the segment database 158, or alternatively, a user can be assigned to a custom targeted segment defined to meet specific goals of a content provider.

Based on the assigned segments, the user profile database 156 can be updated to reflect the segment assignments. Additionally, the content delivery system 106 can use the segment assignments to select targeted content. In some cases, the user profile data in the user profile database 156 can change over time so the segment assigner module 126 can be configured to periodically update the segment assignments in the user profile database 156. The segment assignment update can be triggered at specified intervals, upon detection of a change in the user profile database 156, and/or upon detection of a specified activity in the content delivery system 106.

In some embodiments, the content delivery system 106 can provide a prioritizer module 128. The prioritizer module 128 can perform a variety of prioritizing tasks based on the configuration of the content delivery system 106. In some configurations, the prioritizer module 128 can prioritize the targeted segments assigned to a user. The prioritization can be influenced by a number of factors, which can include the user's context, a content provider's campaign goals, and/or the content that is currently available for display to the user. A request to prioritize the targeted segments can be explicit or implicit and can be made by any component of the system 100. For example, a secondary content provider 110 can explicitly request that the content delivery system 106 prioritize the targeted segments or the request can be implicit as part of a request for a content package. The resulting prioritized list can be provided, for example, to the content management module 122, which can then use the information to assemble and deliver a content package. Additionally, the prioritized list can be stored, for example in the user profile, for later use.

While the content delivery system 106 is presented with specific components, it should be understood by one skilled in the art, that the architectural configuration of system 106 is simply one possible configuration and that other configurations with more or less components are also possible.

As described above, one aspect of the present technology is the gathering and use of data available from various sources to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, or any other identifying information.

The present disclosure recognizes that the use of such personal information data, in the present technology, can be used to the benefit of users. For example, the personal information data can be used to deliver targeted content that is of greater interest to the user. Accordingly, use of such personal information data enables calculated control of the delivered content. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services. In another example, users can select not to provide location information for targeted content delivery services. In yet another example, users can select to not provide precise location information, but permit the transfer of location zone information.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publically available information.

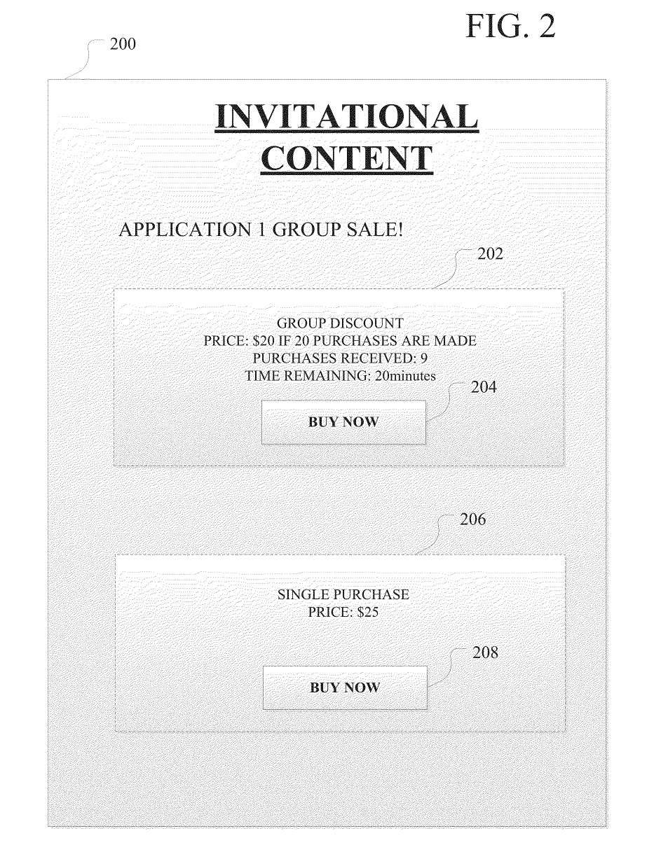

FIG. 2 illustrates an example group invitational content item 200. The group invitational content item 200 can be a mobile invitational content item and/or any other type of invitational content. In some embodiments, the group invitational content item is a mobile invitational content item presented to one or more users at the user's respective mobile device. A mobile device can include, for example, a smartphone, a tablet computer, a laptop computer, a portable media player, etc. In some embodiments, the group invitational content item can be presented to a user within an application and/or media content. In other embodiments, the group invitational content item can be presented to a user within a browser window. In still other embodiments, the group invitational content item can be presented to a user as a standalone content item. The group invitational content item can be for any product and/or service. For example, the group invitational content item can be for an application, media content, multiple content items, a standalone content item, “freemium” content, etc.

The group invitational content item 200 can include a group discount 202 indicating a discount price of the product/service based on a number of purchases of the product/service. In some embodiments, the group invitational content item 200 can include additional group discounts indicating varying, respective discount prices based on different numbers of purchases. Moreover, the discount price in the group discount 202 can be configured to remain valid for a period of time. Further, the group discount 202 can include a timer indicating the amount of time remaining before the period of time, and consequently the group invitational content item 200, expires. The group discount 202 can include a buy now feature 204, which a user can select to submit an offer to purchase the product/service. When a user submits an offer to purchase the product/service, the offer to purchase the product/service from the user can then be added to a list of purchases of the product/service. When the list of purchases reaches the volume threshold to complete the offer (e.g., the number of purchases required for the discount price), the advertiser can accept the offer to purchase the product/service, and any other offers, and finalize the purchase. The group invitational content 200 can then be updated to reflect the fact that the offer to purchase the product/service has been confirmed. At the end of the pricing campaign, if an insufficient number of orders are received for the discount price, the invitational content 200 can present an offer to purchase the product/service at full price or any other price to those users who submitted an offer to purchase the product/service.

The group invitational content 200 can also include a full price option 206 indicating a full price of the product/service for a single purchase of the product/service. The full price option 206 can include a buy now feature 208, which allows the user to purchase the product/service at the full price. The user can thus purchase the product/service at the full price if she does not want to wait for the period of time configured for the group discount 202 to expire in order to finalize the purchase, as the buy now feature 208 allows the user to submit an offer to immediately purchase the product/service at the full price. However, in some embodiments, the buy now feature 208 can be configured to serve as an offer to purchase the product/service at the full price contingent on the number of purchases required for the group discount 202 not being sufficient at the end of the period of time required for the group discount 202.

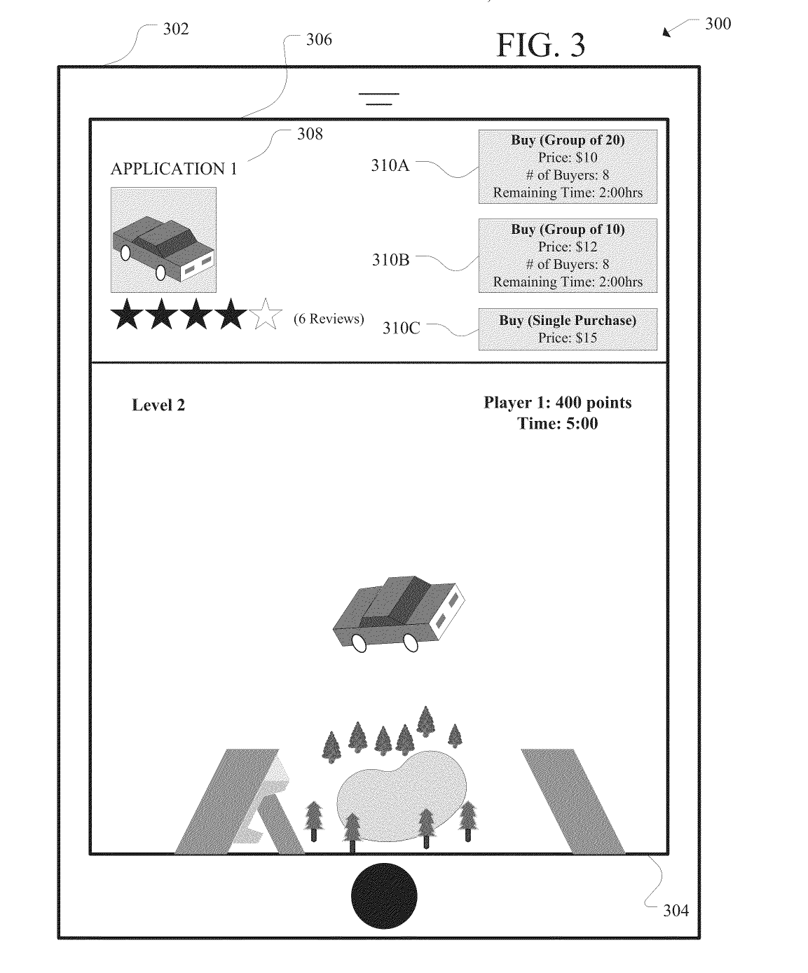

FIG. 3 illustrates an example presentation 300 of a group invitational content item 306 for mobile content. The group invitational content item 306 can be presented on mobile device 302, which can be any mobile device with a display, such as a smartphone, a tablet computer, a laptop computer, etc. Moreover, the group invitational content item 306 can be presented as a banner within a mobile application 304. However, in some embodiments, the group invitational content item 306 can be presented as a standalone invitational content and/or a link within the mobile application 304. The group invitational content item 306 can be for any media content which can be purchased from the mobile device 302. For example, the group invitational content item 306 can be for application 308 for the mobile device 302. The user of the mobile device 302 can purchase the application 308 in the group invitational content item 306 by selecting any of the buy buttons 310A-C. The buy buttons 310A-C can be integrated with the group invitational content item 306 to provide the purchase features to the group invitational content item 306. For example, the buy buttons 310A-C can be clickable buttons that can be selected by the user to submit an offer to purchase the application 308. In some embodiments, the buy buttons 310A-C can be links to a separate window or browser page where the user can submit a purchase offer for the application 308. In other embodiments, the buy buttons 310A-C can be buttons with code for executing a purchasing action, such as a script for submitting a purchase offer.

The buy buttons 310A-C can be configured based on varying pricing structures. For example, buy button 310A can have a group discount price of $10 if the number of buyers of the application 308 reaches 20 buyers with a period of time. Here, the buy button 310A can indicate the number of buyers that have purchased the application 308 thus far (e.g., 8 buyers) and the remaining time for the group discount (e.g., 2 hours). In some embodiments, the buy button 310A can include a timer for displaying the remaining time for the group discount. Further, the buy button 310A can be updated as the number of buyers and/or the remaining time changes. When the user selects the buy button 310A, the user can be added to the number of buyers. Moreover, as other users select the buy button 310A on their respective devices, they can also be added to the number of buyers. If the number of buyers reaches the required amount (i.e., 20) within the period of time, the purchase offer submitted by the users can be accepted at the group discount price associated with the buy button 310A. On the other hand, if the period of time expires before the number of buyers reaches the required amount, the purchase offers can be rejected by the advertiser. However, in some embodiments, the advertiser can review the number of buyers after the period of time expires and either accept the purchase offers at the group discount price or extend the period of time. If the purchase offers are rejected by the advertiser, the group invitational content item 306 can be updated to reflect the status of the purchase offers and provide alternative purchasing options, such as alternative prices.

Moreover, buy button 310B can have a group discount price of $12 if the number of buyers of the application 308 reaches 10 buyers within a period of time. Here, the group discount price is higher than the group discount price associated with buy button 310A, as the number of buyers required is smaller. In this way, the group discount prices in the group invitational content item 306 can be adjusted based on the number of buyers required for a purchase. The period of time associated with the group discount of buy button 310B can be the same as the period of time associated with the group discount of buy button 310A. However, in some embodiments, the group discount of buy button 310B can have a different period of time than the group discount of buy button 310A.

The buy button 310C can include the actual price of the application 308 (i.e., $15). Thus, the buy button 310C can provide the user with an option to purchase the application 308 at the regular price if the number of buyers is not sufficient for a group discount and/or if the user does not want to wait for the period of time associated with the group discounts to expire. In some embodiments, the group invitational content item 306 can also include additional buy buttons based on different group purchasing requirements, for example. Moreover, while the group invitational content item 306 is illustrated in FIG. 3 as having multiple buy buttons, the group invitational content item 306 can otherwise include a single buy button, where the user can submit an offer to purchase the application 308 at a price determined based on the number of buyers after a specific period of time. For example, the group invitational content item 306 can list different group discount prices based on varying numbers of buyers, and a single buy button where the user can submit an offer to purchase the application 308 at the lowest group discount price available for the number of buyers at the end of the period. Thus, the user can commit to purchase the application 308 at a price that can vary as the number of buyers changes. Indeed, in some embodiments, the group invitational content item 306 can be presented without any buy buttons. Here, the group invitational content item 306 itself can include a link to a purchasing page and/or code to execute a purchase-related action when the group invitational content item 306 is selected. Thus, the user can submit an offer to purchase the application 308 by simply clicking and/or selecting the group invitational content item 306.

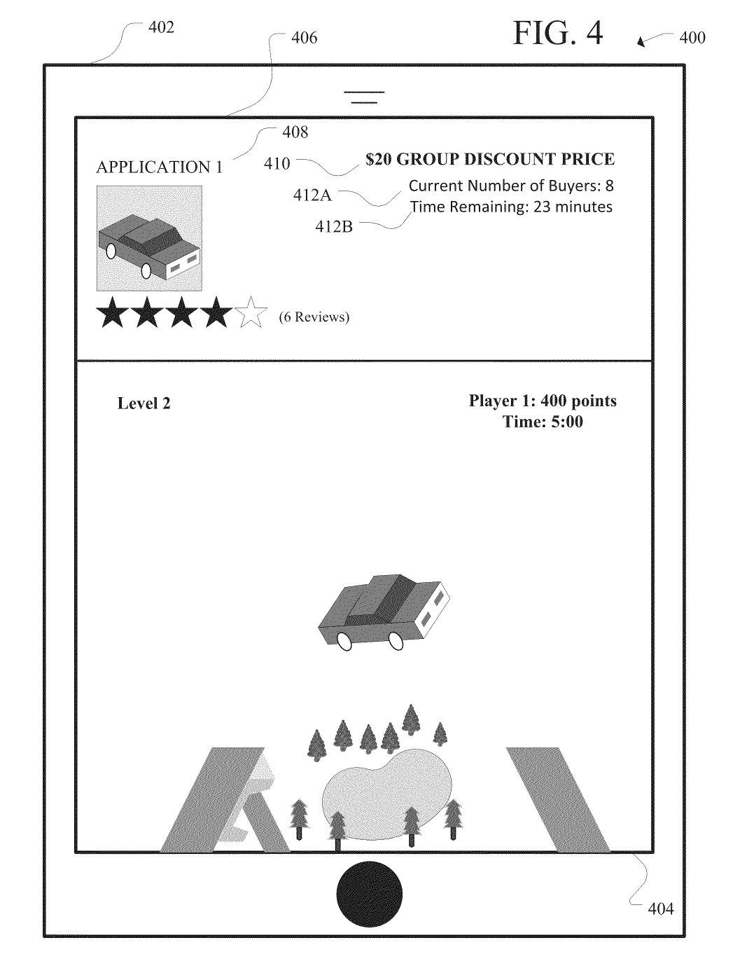

FIG. 4 illustrates an example presentation 400 of a dynamic group invitational content 406 for mobile content. The dynamic group invitational content 406 can be presented on mobile device 402, which can be any mobile device with a display, such as a smartphone, a tablet computer, a laptop computer, etc. Moreover, the dynamic group invitational content 406 can be presented as a banner within a mobile application 404. However, in some embodiments, the dynamic group invitational content 406 can be presented as a standalone invitational content and/or a link within the mobile application 404. The dynamic group invitational content 406 can be for any media content which can be purchased from the mobile device 402. For example, the dynamic group invitational content 406 can be for application 408 for the mobile device 402.

The dynamic group invitational content 406 includes a group discount price 410, which is dynamically based on the current number of buyers of the application 408. Thus, as more users purchase the application 408, the group discount price 410 can go down to reflect the cheaper, volume pricing associated with the larger number of buyers. The pricing can be dynamically adjusted to obtain the maximum profit. For example, the pricing can be tweaked based on previous and/or current performance. As the group discount price 410 changes based on the number of buyers and pricing optimization options, the dynamic group invitational content 406 can be updated to reflect the current price.

The dynamic group invitational content 406 can also include the number of current buyers 412A of the application 408 and the time remaining 412B in the current invitational content campaign. Moreover, the user can simply click and/or select the dynamic group invitational content 406 to submit an offer to purchase the application 408. Thus, when the user clicks on the dynamic group invitational content 406, she can submit an offer to purchase the application 408, and the group discount price 410 can be updated to reflect the new buyer.

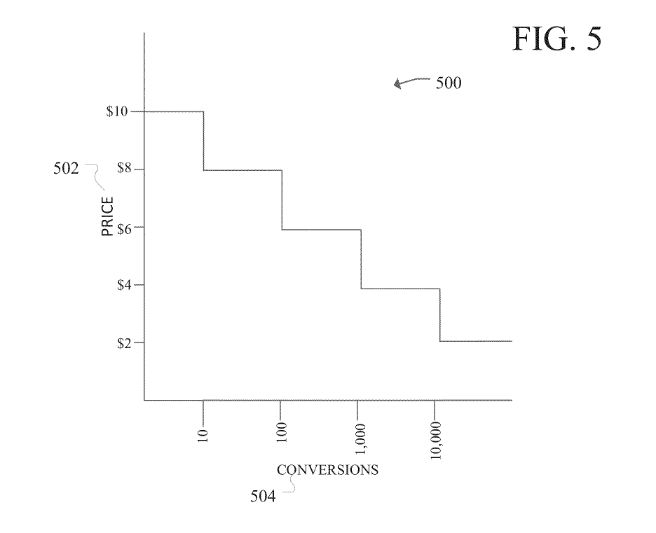

FIG. 5 illustrates an example discount pricing graph 500. The discount pricing graph 500 includes varying price ranges 502 and conversions 504. Here, the price can go down as the number of people purchasing an item goes up. For example, the price of an item can be $8 if ten or more people purchase the item, and $6 if 100 or more people purchase the item. In some aspects, the discount pricing graph 500 can also be based on more than one item. For example, the discount pricing graph 500 can be based on two products, where the price of at least one of the products goes down as more people purchase at least one of the products. In other aspects, the discount pricing graph 500 can be plotted as a curve, depending on the pricing configuration. Moreover, the price ranges 502 and conversions 504 are shown for illustration purposes, and as one of ordinary skill in the art will readily recognize after reading this disclosure, the price ranges 502 and conversions 504 can vary in other embodiments.

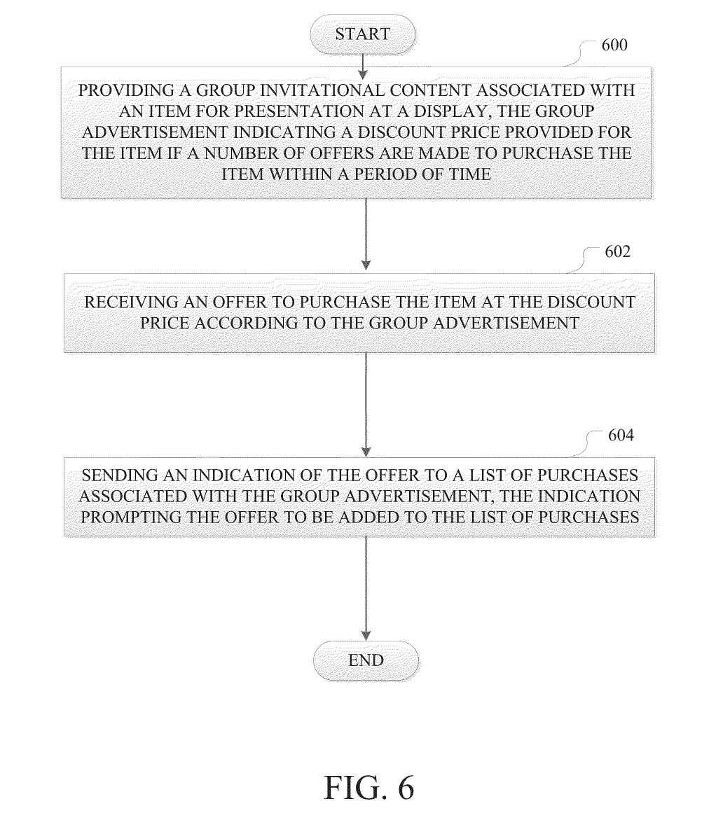

Having disclosed some basic system components and concepts, the disclosure now turns to the exemplary method embodiment shown in FIG. 6. For the sake of clarity, the method is described in terms of user terminal 102ᵢ, as shown in FIG. 1, configured to practice the method. The steps outlined herein are exemplary and can be implemented in any combination thereof, including combinations that exclude, add, or modify certain steps.

User terminal 102ᵢ can first provide a group invitational content associated with an item for presentation at the user terminal 102ᵢ, the group invitational content indicating a discount price provided for the item if a number of offers are made to purchase the item within a period of time (600). User terminal 102ᵢ can provide the group invitational content to a display, a browser, an application, a GUI, and/or a window at user terminal 102ᵢ to be presented to a user. User terminal 102ᵢ can also provide, present, and/or display a timer indicating an amount of time left before the group invitational content expires. This can be the amount of time remaining in the period of time associated with the group invitational content. Also, user terminal 102ᵢ can receive the group invitational content for presentation to the user from another device, such as content delivery system 106, for example. In some cases, the group invitational content can indicate the full price of the item. The group invitational content can also indicate additional discount prices for the item based on a different number of purchases which must be made within the period of time or a different period of time, for example.

The group invitational content can be for any product or service. For example, the group invitational content can be for media content, such as a mobile application or a music file. Further, the discount price can be based on the current number of purchases. For example, the discount price can decrease as the number of purchases increases. In this sense, the discount price can be static or tiered. However, in some aspects, the discount price can be dynamic. User terminal 102ᵢ can update the discount price displayed in the group invitational content as a new threshold of purchases associated with the updated discount price is reached. In other aspects, user terminal 102ᵢ and/or content delivery system 106 can dynamically determine when to launch discounts and/or how much to discount. This can be subject to constraints set in advertiser preferences for a minimum price and a maximum number and/or duration of discounts offered. User terminal 102ᵢ and/or content delivery system 106 can optimize the discount price to maximize advertiser profit. Moreover, user terminal 102ᵢ and/or content delivery system 106 can keep track of how much profit (e.g., cost charged for application and/or content minus the cost to the advertiser, such as a cost per action amount charged by the advertising network) was made on a per impression unit basis for each burst of discounts offered. When determining what price to use for a subsequent discount burst, user terminal 102ᵢ and/or content delivery system 106 can choose whichever price previously performed best within a configurable time window, such as a week, a month, and so forth. User terminal 102ᵢ and/or content delivery system 106 can then choose to add n cents, subtract n cents, or keep the original value, where n can be a configurable parameter determining how exploratory the pricing algorithm should be. In addition, the record of past pricing performance can be reset any time the overall targeting of the algorithm is altered, with the initial post-reset value being the best performing price under the old targeting, for example.

Next, user terminal 102ᵢ can receive an offer to purchase the item at the discount price according to the group invitational content (602). User terminal 102ᵢ can then send an indication of the offer to a list of purchases associated with the group invitational content, the indication prompting the offer to be added to the list of purchases (604). User terminal 102ᵢ can send the indication to a remote server, such as content delivery system 106, or a database on user terminal 102ᵢ. The list of purchases can be a list stored on user terminal 102ᵢ and/or a remote server, such as content delivery system 106, for example. Based on the list of purchases, user terminal 102ᵢ or content delivery system 106 can update the group invitational content to indicate how many purchases of the item have been made and/or how many additional purchases of the item must be made according to the offer. User terminal 102ᵢ or content delivery system 106 can accept the offer to purchase the item when the number of offers required by the invitational content are made. User terminal 102ᵢ can finalize the purchase of the item based on the offer to purchase the item previously received by user terminal 102ᵢ. If the period of time expires before the required number of offers are made, user terminal 102ᵢ can present an option to purchase the item at the full price, or any other price determined by user terminal 102ᵢ, content delivery system 106, or the advertiser.

In some embodiments, user terminals 102 can present the group invitational content to multiple users and receive multiple offers to purchase the item at the discount price within the period of time. User terminals 102 can then add the multiple offers to purchase the item to a respective list of purchases and/or transmit the multiple offers to a central device, such as content delivery system 106, to be added to a central list of purchases. User terminals 102 can also update the group invitational content to indicate how many offers have been received, how many additional offers must be received according to the group discount, and/or how much time remains before the group discount expires.

When the number of offers received meets the number of offers required by the group invitational content for the particular discount price, user terminal 102ᵢ and/or content delivery system 106 can accept the offers and finalize the purchases. If the number of offers received do not meet the number of offers required when the period of time expires, user terminal 102ᵢ and/or content delivery system 106 can present any users that made an offer with an offer to purchase the item at the full price and/or any price determined by user terminal 102ᵢ, content delivery system 106, or advertiser. Moreover, if before the period expires the number of offers received reaches the number of offers required by the group discount displayed in the group invitational content, user terminal 102ᵢ and/or content delivery system 106 can dynamically update the group discount price displayed in the group invitational content according to a new group discount price, which can be based on a different threshold of purchases. For example, if the group invitational content indicates a group discount price of $20 if 20 purchases are received within 3 days, and the 20 purchases are indeed received within the 3 days, then user terminal 102ᵢ can update the group invitational content to indicate a group discount price of $18 if 30 purchases are received within the remaining period of time. In this way, the group discount price reflected in the group invitational content can be dynamically based on the number of purchases made/received.

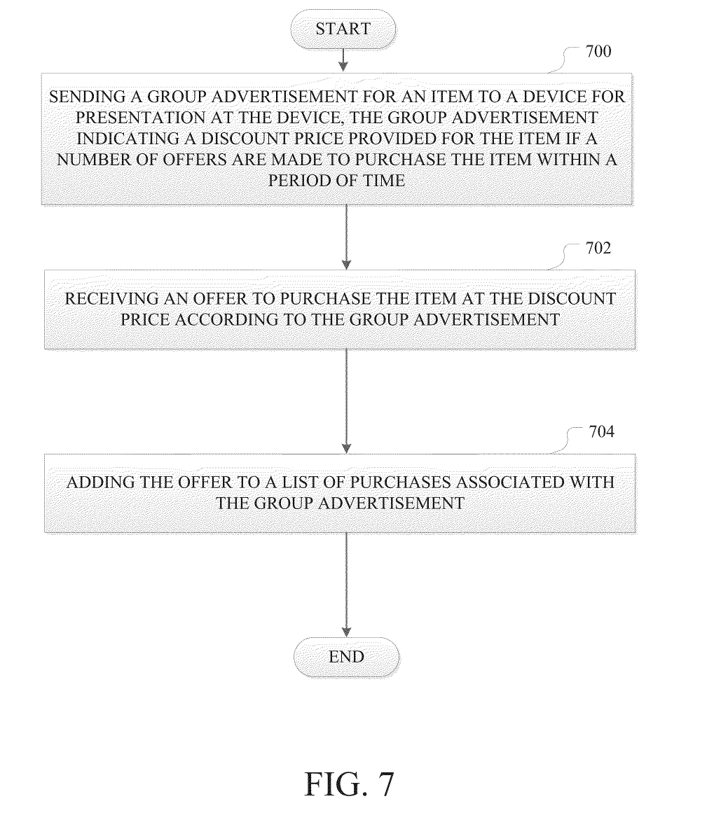

The disclosure now turns to the exemplary method embodiment shown in FIG. 7. For the sake of clarity, the method is described in terms of content delivery system 106, as shown in FIG. 1, configured to practice the method. The steps outlined herein are exemplary and can be implemented in any combination thereof, including combinations that exclude, add, or modify certain steps.

Content delivery system 106 first sends a group invitational content for an item to a device for presentation at the device, the group invitational content indicating a discount price provided for the item if a number of offers are made to purchase the item within a period of time (700). Here, the device can include any user terminal, such as user terminal 102ᵢ, illustrated in FIG. 1. Moreover, content delivery system 106 can retrieve the group invitational content from a local or remote storage of invitational content. The storage of invitational content can include various group invitational content for the item. For example, the storage of invitational content can include group invitational content indicating different discount prices and/or number of purchases required for the item. This way, content delivery system 106 can select from storage a new group invitational content to send to the device when an update to the price and/or volume indicated in the current group invitational content is necessary.

Content delivery system 106 can send the group invitational content for presentation to a user of the device. The device can then present the group invitational content to the user as a standalone invitational content, a web page, a link or banner within mobile content, an invitational content within a mobile application, an invitational content page at the mobile device, etc. The discount price in the group invitational content can be based on the volume of purchases and/or the length of the period of time, for example. The discount price can also be dynamically selected and/or adjusted by content delivery system 106 prior to, and/or after, the group invitational content is presented to the user. For example, content delivery system 106 can analyze the current and/or prior performance of the group invitational content and adjust the discount price in order to maximize profit. Also, content delivery system 106 can dynamically lower the discount price as the number of purchases increases. For example, if the number of purchases received during the period of time exceeds the number of orders required for the current discount price, content delivery system 106 can send an updated group invitational content with a new discount price to the device. The updated group invitational content can indicate a new discount price and/or a new number of purchases required for the new discount price to apply.

Next, content delivery system 106 receives an offer to purchase the item at the discount price according to the group invitational content (702). Content delivery system 106 then adds the offer to a list of purchases associated with the group invitational content (704). When the period of time expires, if the number of purchases in the list of purchases meets or exceeds the number of offers that must be made for the discount price to apply, content delivery system 106 can accept the offers and finalize the purchase at the discount price. Alternatively, if the number of purchases does not meet or exceed the number of offers required at the end of the period of time, then content delivery system 106 can send a prompt to the device asking the user if she would like to purchase the item at the full price or any other price selected by content delivery system 106.

If before the period expires, the number of purchases in the list of purchases meets or exceeds the number of offers required for the discount price to apply, content delivery system 106 can send an updated group invitational content item to the device indicating a new discount price and a new number of offers required for the new discount price to apply. The updated group invitational content can also indicate the number of purchases that have been received, the number of additional purchases that must be received for the new discount price to apply, the time remaining before the group invitational content expires, the amount of time that has elapsed since the campaign associated with the group invitational content began, the current discount price that applies given the current number of offers made, etc. Content delivery system 106 can retrieve the updated group invitational content from a storage of invitational contents in order to send the updated group invitational content to the device. For example, if the current group invitational content indicates a discount price of $10 for 10 purchases, and content delivery system 106 receives 10 or more offers before the period of time expires, then content delivery system 106 can retrieve from storage a new group invitational content to send to the device based on the next pricing tier. Thus, if the next pricing tier is $8 discount price for 20 purchases, content delivery system 106 can select the group invitational content indicating the $8 discount price for 20 purchases, and send the group invitational content to the device to be presented to the user.

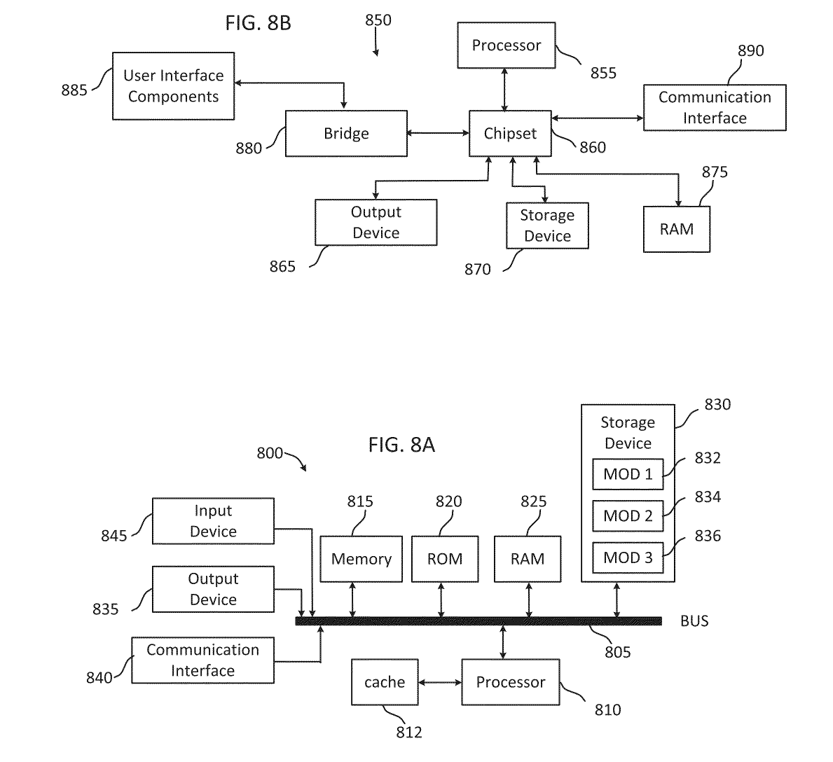

FIG. 8A and FIG. 8B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 8A illustrates a conventional system bus computing system architecture 800 wherein the components of the system are in electrical communication with each other using a bus 805. Exemplary system 800 includes a processing unit (CPU or processor) 810 and a system bus 805 that couples various system components including the system memory 815, such as read only memory (ROM) 820 and random access memory (RAM) 825, to the processor 810. The system 800 can include a cache of high-speed memory connected directly with, in close proximity to, or integrated as part of the processor 810. The system 800 can copy data from the memory 815 and/or the storage device 830 to the cache 812 for quick access by the processor 810. In this way, the cache can provide a performance boost that avoids processor 810 delays while waiting for data. These and other modules can control or be configured to control the processor 810 to perform various actions. Other system memory 815 may be available for use as well. The memory 815 can include multiple different types of memory with different performance characteristics. The processor 810 can include any general purpose processor and a hardware module or software module, such as module 1 832, module 2 834, and module 3 836 stored in storage device 830, configured to control the processor 810 as well as a special-purpose processor where software instructions are incorporated into the actual processor design. The processor 810 may essentially be a completely self-contained computing system, containing multiple cores or processors, a bus, memory controller, cache, etc. A multi-core processor may be symmetric or asymmetric.

To enable user interaction with the computing device 800, an input device 845 can represent any number of input mechanisms, such as a microphone for speech, a touch-sensitive screen for gesture or graphical input, keyboard, mouse, motion input, speech and so forth. An output device 835 can also be one or more of a number of output mechanisms known to those of skill in the art. In some instances, multimodal systems can enable a user to provide multiple types of input to communicate with the computing device 800. The communications interface 840 can generally govern and manage the user input and system output. There is no restriction on operating on any particular hardware arrangement and therefore the basic features here may easily be substituted for improved hardware or firmware arrangements as they are developed.

Storage device 830 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 825, read only memory (ROM) 820, and hybrids thereof.

The storage device 830 can include software modules 832, 834, 836 for controlling the processor 810. Other hardware or software modules are contemplated. The storage device 830 can be connected to the system bus 805. In one aspect, a hardware module that performs a particular function can include the software component stored in a computer-readable medium in connection with the necessary hardware components, such as the processor 810, bus 805, display 835, and so forth, to carry out the function.

FIG. 8B illustrates a computer system 850 having a chipset architecture that can be used in executing the described method and generating and displaying a graphical user interface (GUI). Computer system 850 is an example of computer hardware, software, and firmware that can be used to implement the disclosed technology. System 850 can include a processor 855, representative of any number of physically and/or logically distinct resources capable of executing software, firmware, and hardware configured to perform identified computations. Processor 855 can communicate with a chipset 860 that can control input to and output from processor 855. In this example, chipset 860 outputs information to output 865, such as a display, and can read and write information to storage device 870, which can include magnetic media, and solid state media, for example. Chipset 860 can also read data from and write data to RAM 875. A bridge 880 for interfacing with a variety of user interface components 885 can be provided for interfacing with chipset 860. Such user interface components 885 can include a keyboard, a microphone, touch detection and processing circuitry, a pointing device, such as a mouse, and so on. In general, inputs to system 850 can come from any of a variety of sources, machine generated and/or human generated.

Chipset 860 can also interface with one or more communication interfaces 890 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 855 analyzing data stored in storage 870 or 875. Further, the machine can receive inputs from a user via user interface components 885 and execute appropriate functions, such as browsing functions by interpreting these inputs using processor 855.

It can be appreciated that exemplary systems 800 and 850 can have more than one processor 810 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Claim language reciting “at least one of” a set indicates that one member of the set or multiple members of the set satisfy the claim.

We claim:

1. A method comprising:
providing, via a processor, a group invitational content associated with an item for presentation at a display, the group invitational content indicating a discount price provided for the item if a number of offers are made to purchase the item within a period of time;
receiving an offer to purchase the item at the discount price according to the group invitational content; and
sending an indication of the offer to a list of purchases associated with the group invitational content, the indication prompting the offer to be added to the list of purchases.

2. The method of claim 1, wherein the group invitational content indicates a full price associated with the item.

3. The method of claim 1, wherein the group invitational content indicates a second discount price provided for the item if a second number of purchases are made within the period of time, wherein the discount price and the second discount price are based on pricing tiers.

4. The method of claim 1, further comprising:
receiving an instruction to accept the offer to purchase the item at the discount price when the number of offers are made; and
accepting the offer to purchase the item at the discount price.

5. The method of claim 1, wherein the discount price is dynamic, and wherein the discount price is modified based on a performance of the group invitational content.

6. The method of claim 1, further comprising accepting the offer to purchase the item at the discount price when the number of offers are made.

7. The method of claim 1, further comprising receiving the group invitational content from a server and presenting the group invitational content to a user via the display.

8. The method of claim 1, further comprising updating the group invitational content to indicate how many purchases of the item have been made based on the list of purchases.

9. The method of claim 1, wherein the group invitational content includes a timer indicating an amount of time left before the group invitational content expires.

10. A system comprising:
a processor, and
a computer-readable storage medium having stored therein instructions which, when executed by the processor, cause the processor to perform operations comprising:
sending, via a processor, a group invitational content for an item to a device for presentation at the device, the group invitational content indicating a discount price provided for the item if a number of offers are made to purchase the item within a period of time;
receiving an offer to purchase the item at the discount price according to the group invitational content; and
adding the offer to a list of purchases associated with the group invitational content.

11. The system of claim 10, wherein the group invitational content further indicates a full price associated with the item.

12. The system of claim 10, wherein the group invitational content indicates a second discount price provided for the item if a second number of purchases are made within the period of time, wherein the discount price and the second discount price are based on pricing tiers.

13. The system of claim 10, the operations further comprising:
receiving a plurality of offers to purchase the item at the discount price within the period of time;
adding the plurality of offers to the list of purchases associated with the group invitational content; and
accepting the plurality of offers to purchase the item at the discount price when the plurality of offers satisfies the number of offers according to the group invitational content.

14. The system of claim 10, wherein the discount price is dynamic, and wherein the discount price is optimized to maximize advertiser profit.

15. The system of claim 10, the operations further comprising:
determining that the number of offers have been received; and
sending an instruction to the device to accept the offer to purchase the item at the discount price.

16. The system of claim 10, the operations further comprising sending, to the device, a request to update the group invitational content to indicate how many purchases of the item have been made based on the list of purchases, the request specifying how many purchases of the item have been made.

17. The system of claim 10, the operations further comprising providing a timer indicating an amount of time left before the group invitational content expires.

18. A computer-readable medium storing computer executable instructions for causing a processor to perform the operations comprising:
sending, via a processor, a group invitational content for an item to a device for presentation at the device, the group invitational content indicating a discount price provided for the item if a number of offers are made to purchase the item within a period of time;
receiving an offer to purchase the item at the discount price according to the group invitational content;
adding the offer to a list of purchases associated with the group invitational content; and
providing an update of the group invitational content to indicate how many purchases of the item have been made based on the list of purchases.

19. The computer-readable medium of claim 18, the operations further comprising providing a timer indicating an amount of time left before the group invitational content expires.

20. The computer-readable medium of claim 18, the operations further comprising:
receiving a plurality of offers to purchase the item at the discount price within the period of time;
adding the plurality of offers to the list of purchases associated with the group invitational content;
accepting the plurality of offers to purchase the item at the discount price when the plurality of offers satisfies the number of offers according to the group invitational content; and
sending, to the device, a request to finalize the purchase of the item based on the offer.
